(19) United States
(12) Patent Application Publication
(10) Pub. No.: US 2024/0104607 A1
(43) Pub. Date: Mar. 28, 2024

(54) APPARATUS AND METHODS FOR COLLABORATIVE ADVERTISING AND MARKETING CAMPAIGNS

(71) Applicant: Cosmo Moshe Grill, Apalachin, NY (US)

(72) Inventor: Cosmo Moshe Grill, Apalachin, NY (US)

(21) Appl. No.: 18/135,014

(22) Filed: Apr. 14, 2023

Related U.S. Application Data
(63) Continuation-in-part of application No. 17/955,104, filed on Sep. 28, 2022.

(51) Int. Cl. G06Q 30/0241; G06Q 10/101; G06Q 30/0601

(52) U.S. Cl. CPC G06Q 30/0276; G06Q 10/101; G06Q 30/0277; G06Q 30/0641

(57) ABSTRACT

An apparatus and methods are provided for advertising partnership campaigns. The advertising partnership campaign attracts partnering brands to participate in brand partnership campaigns. The brand partnership campaign advertises and hosts a micro-store that includes a combination of products from all the participating partnering brands. Advertising content is developed, managed, and optimized across a variety of common online advertising placements. The brand partnership campaign identifies and contracts content creators, creative directors, production studios, or software to develop the advertising content. Data and analytics about the performance of the brand partnership campaign are collected and compiled into performance reports. Analytics are reported to each partnering brand about the performance of its portion of the brand partnership campaign until the campaign concludes.

### PRIORITY

This application is a continuation-in-part of, and claims the benefit of, U.S. patent application, entitled “Apparatus And Methods For Collaborative Advertising And Marketing Campaigns,” filed on Sep. 28, 2022, and having application Ser. No. 17/955,104, the entirety of said application being incorporated herein by reference.

### FIELD

Embodiments of the present disclosure generally relate to advertising and marketing. More specifically, embodiments of the disclosure relate to an apparatus and methods for collaborative digital advertising and marketing campaigns.

### BACKGROUND

When manufacturers, venders, retailers, service providers, and the like (hereinafter, “brands”) want to advertise merchandise, they typically buy their own ads with their own brand only. Generally, such brands have their own advertising agency and media buyers, or they spend directly on advertising platforms, advertising networks, or advertising exchanges. Brands typically send traffic to their own web site or app. In some instances, a brand may partner with one or more other brands to form a brand partnership campaign. However, such brand partnership campaigns typically are performed without paid media. Instead, brand partnership campaigns typically are done organically or outside of the paid digital advertising market.

A drawback to conventional brand partnership campaigns is that when the brand partners buy digital advertisement to boost their brand partnership campaigns, the brand partners run into transparency issues that are confusing. For example, when brand partners purchase digital ads, the brand partners may be confused about which partner is running the ads and which partner is reporting about the effectiveness of the ads. Partnering brands may become confused about how to view ad-related data pertaining to other partnering brands. Further, stakeholders aren't neutral, so they will tend to optimize towards their own brand's performance rather than equally across the other partnering brands.

Another drawback to conventional brand partnership campaigns is that partnering brands may be confused about which brand is in charge of vetting brand partners and which partner brand will be defining the objectives of the brand partnership campaign. Other sources of confusion often include determining which brand is in charge of developing the creative for the brand partnership campaign, as well as determining which partner brand is in control of funding issues such as which brand partner will accept money and spend the money appropriately and which brand partner will oversee how the money is spent.

In general, conventional brand partnership campaigns are difficult because each brand partner has their own media managers, advertising accounts, and websites or apps—and also each brand will have different digital ad optimization objectives. What is needed, therefore, is an apparatus and methods for collaborative digital advertising and marketing campaigns wherein a mediating, neutral party orchestrates a multi-brand campaign that's powered with advertising and real-time ad optimization.

### SUMMARY

An apparatus and methods are provided for advertising partnership campaigns. The advertising partnership campaign attracts partnering brands to participate in brand partnership campaigns. The brand partnership campaign advertises and hosts a micro-store that includes a combination of products from all the participating partnering brands. Advertising content is developed, and ads are purchased, managed, and optimized across a variety of advertising placements. The brand partnership campaign identifies and contracts content creators, creative directors, production studios, or specialized content creation software to develop the advertising content. Data and analytics about the performance of the brand partnership campaign are collected and compiled into performance reports. Analytics are reported to each partnering brand about the performance of its portion of the brand partnership campaign until the campaign concludes.

In an exemplary embodiment, a brand-specific advertising and marketing platform comprises: a campaign server system comprising a non-transient machine-readable medium and at least one processor; an advertising partnership platform stored on a memory of the campaign server system for operating a brand partnership campaign; an interface for providing access to partnering brands participating in the brand partnership campaign; a database for storing information pertaining to the brand partnership campaign and the partnering brands; and a suite of brand-specific components providing partnering brands interactivity with the brand partnership campaign.

In another exemplary embodiment, the brand-specific components comprise modules whereby each partnering brand may access and participate in the brand partnership campaign. In another exemplary embodiment, the brand-specific components include any one or more of a landing page, a dashboard, performance reports, advertising placements, and a micro-store. In another exemplary embodiment, the micro-store comprises a shared landing page that includes a combination of the products from all the participating partnering brands. In another exemplary embodiment, the landing page comprises a page that is specific to each partnering brand and enables the partnering brand to view and interact with its portion of the brand partnership campaign. In another exemplary embodiment, the dashboard comprises a graphical user interface whereby each partnering brand can view and access analytics pertaining to the performance of the brand partnership campaign.

In an exemplary embodiment, a process for managing a collaborative advertising and marketing campaign comprises: attracting partnering brands to participate in a brand partnership campaign; developing advertising content; creating a shared landing page; collecting funds from the partnering brands; producing reports with partnering brands; and concluding the brand partnership campaign.

In another exemplary embodiment, attracting the partnering brands includes posting a campaign brief directed to one or more product types that may be advertised by way of the brand partnership campaign. In another exemplary embodiment, developing advertising content includes producing and testing of advertising content pertaining to the brand partnership campaign. In another exemplary embodiment, developing advertising content includes identifying and contracting any one or more of a content creator, a creative director, a production studio, or a specialized content creation software, to develop advertising content for the campaign. In another exemplary embodiment, developing advertising content includes managing and optimizing advertising content across a variety of common online advertising placements, including, but not limited to, search ads, social media ads, newsfeed ads, content recommendation ads, audio ads, mobile ads, interstitial ads, video ads, in-stream ads, display ads, influencer ads, email ads, newsletter ads, native ads, promoted content ads, rich media ads, retargeting ads, carousel ads, affiliate marketing ads, newsletter ads, popup ads, pop under ads, and/or interactive ads.

In another exemplary embodiment, creating a shared landing page comprises creating a micro-store that includes a combination of the products from all the partnering brands. In another exemplary embodiment, creating a shared landing page further includes developing a brand-specific page directed to each of the partnering brands. In another exemplary embodiment, producing reports includes providing a dashboard to each partnering brand. In another exemplary embodiment, providing the dashboard includes configuring the dashboard to report to the partnering brand on the performance of its portion of the brand partnership campaign. In another exemplary embodiment, configuring the dashboard includes collecting and compiling analytics to report to the partnering brands.

In another exemplary embodiment, collecting funds includes directing the partnering brands to make equal payments for the operation of the brand partnership campaign. In another exemplary embodiment, collecting funds includes retaining a small fee for the operation of the brand partnership campaign. In another exemplary embodiment, retaining the small fee includes directing remaining funds toward operating the brand partnership campaign. In another exemplary embodiment, directing the remaining funds includes budgeting funding for advertising development and online advertising placements.

In an exemplary embodiment, a process for managing a brand partnership campaign comprises: attracting partnering brands; developing advertising content; collecting funds from the partnering brands; producing reports with partnering brands; and concluding the brand partnership campaign.

In another exemplary embodiment, attracting partnering brands comprises of contacting potential partnering brands directly by way of an algorithm or manual labor, in lieu of posting a campaign brief. In another exemplary embodiment, contacting includes using a sales team to identify candidate partnering brands and then forming suitable groups of potential partnering brands. In another exemplary embodiment, contacting includes an artificial intelligence to identify candidate partnering brands and forming suitable groups of potential partnering brands. In another exemplary embodiment, forming includes creating co-branded advertisements that include links to a website, app or social media profile for each participating partnership brand.

In another exemplary embodiment, the process further comprises creating a shared landing page. In another exemplary embodiment, creating comprises of arranging a micro-store that includes a combination of products from all the partnering brands. In another exemplary embodiment, creating comprises including links to all of the websites or apps of all of the partnering brands. In another exemplary embodiment, creating comprises creating a social media post having links to all of the partnering brands.

In another exemplary embodiment, creating comprises creating a promotional podcast episode that has links to all of the partnering brands. In another exemplary embodiment, creating comprises creating a press-release piece to which advertisements are linked. In another exemplary embodiment, creating comprises an influencer, blogger, or journalist creating a website page that includes mentions of or links to all of the partnering brands. In another exemplary embodiment, creating the micro-store includes using a software tool to merge various products from the partnering brands into a website page.

In another exemplary embodiment, developing advertising content comprises using an artificial intelligence to create co-branded advertisements that include links to a website for each of the partnership brands. In another exemplary embodiment, developing advertising content comprises using an artificial intelligence to: match brands stored within a database comprising the brand partnership campaign; create image or video creatives that is a collage of the matched brands; and contact the matched brands to let them opt-in and share the advertising cost. In another exemplary embodiment, developing advertising content comprises providing an advertising platform that directs users to submit information directly to a form within the advertisement platform and then sends text messages, direct messages and/or emails with content about the partnering brands.

In another exemplary embodiment, developing advertising content comprises promoting a collaborative raffle/giveaway. In another exemplary embodiment, developing advertising content comprises collecting customer leads that are to be marketed to by the partnering brands. In another exemplary embodiment, developing advertising content comprises advertising digital products and services. In another exemplary embodiment, developing advertising content comprises raising awareness of the partnering brands and their products or services.

In another exemplary embodiment, developing advertising content comprises advertising non-profit organizations or NGOs. In another exemplary embodiment, developing advertising content comprises promoting political candidates or political organizations. In another exemplary embodiment, developing advertising content comprises promoting travel destinations.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 is a schematic illustrating an exemplary embodiment of a collaborative advertising and marketing process, according to the present disclosure;

FIG. 2 is a schematic illustrating an exemplary embodiment of a brand-specific advertising platform, according to the present disclosure;

FIG. 3 illustrates process for managing a collaborative advertising and marketing campaign in accordance with the present disclosure; and

FIG. 4 is a block diagram illustrating an exemplary data processing system that may be used with embodiments of a collaborative advertising and marketing platform according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the apparatus and methods disclosed herein may be practiced without these specific details. In other instances, specific numeric references such as “first brand,” may be made. However, the specific numeric reference should not be interpreted as a literal sequential order but rather interpreted that the “first brand” is different than a “second brand.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In some instances, a brand may partner with one or more other brands to form a brand partnership campaign. Such brand partnership campaigns are difficult, however, because each brand partner has their own media managers, advertising accounts, and website or app—and also each brand will have different digital ad optimization objectives. Confusion generally abounds once the brand partners buy digital advertisement to boost their brand partnership campaigns. For example, when brand partners purchase digital ads, the brand partners may be confused about which partner is running the ads and which partner is reporting about the effectiveness of the ads. Partnering brands may become confused about how to view ad-related data pertaining to other partnering brands. Further, partnering brands may be confused about which brand is in charge of developing creative content for the brand partnership campaign, as well as determining which partner brand is in control of funding issues such as which brand partner will accept money and spend the money appropriately and which brand partner will oversee how the money is spent.

Embodiments presented herein provide an apparatus and methods for collaborative digital advertising and marketing campaigns wherein a mediating, neutral party orchestrates a multi-brand campaign that's powered with advertising. In general, the neutral party is a trusted 3^{rd} party that provides a contract and rules for the brand partnership, co-marketing content creation, paid media management, shared landing pages, transparent reporting of ad-related data, and the like.

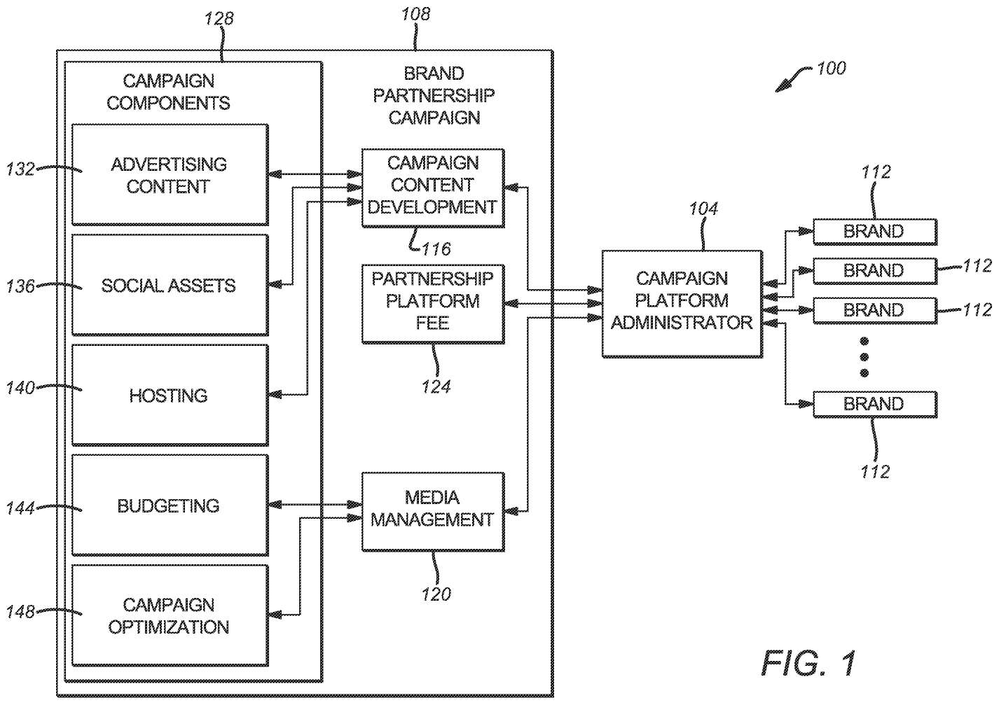

FIG. 1 is a schematic illustrating an exemplary embodiment of a collaborative advertising and marketing process 100, according to the present disclosure. In the process 100 of FIG. 1, a campaign platform administrator 104 orchestrates a brand partnership campaign 108 on behalf of multiple advertisers 112. As will be appreciated, each of the advertisers 112 comprises an entity desiring to advertise branded merchandise or services for sale. As such, each of the advertisers (hereinafter, “partnering brands”) 112 comprises any one or more of a manufacturer, a vender, a retailer, a service provider, and the like, without limitation. Further, in some embodiments, the partnering brands 112 may comprise any of non-profit organizations, non-governmental organizations (NGOs), political organizations, and entities promoting travel destinations. The campaign platform administrator 104 comprises the above-mentioned neutral, trusted 3^{rd} party that provides the contract/rules for the brand partnership, co-marketing content creation, paid media management, shared landing pages, transparent reporting of ad-related data, as described herein.

As shown in FIG. 1, the brand partnership campaign 108 comprises a campaign content development module 116, a media management module 120, and a partnership platform fee module 124 that are provided by the administrator 104 to the partnering brands 112. The modules 116, 120, 124 comprise services that the administrator 104 may perform on behalf of the partnering brands 112. As such, the partnering brands 112 share the cost of operating the brand partnership campaign 108 and consequently their brands will reach more potential customers due to combined media spending.

In one embodiment, for example, three partnering brands 112 can make equal payments, such as $10K each, to the administrator 104 to operate the brand partnership campaign 108. Thus, each of the partnering brands 112 will receive $30K worth of advertising exposure for a cost of $10K. It is contemplated that the advertising exposure will generally grow in direct proportion to the number of partnering brands 112 that join the campaign. Further, in some embodiments, the buy-in payment made by each partnering brand 112 may decrease in direct proportion to the number of partnering brands 112 joining the campaign.

It should be noted that the payments need not be equal, but rather, in some embodiments, the partnering brands 112 may pay different amounts of money. For example, in some embodiments, one or more of the partnering brands 112 may pay more for a higher position on a landing page or a more prominent position in a photo. Further, in some embodiments, one or more of the partnering brands 112 may opt to pay relatively less than other partnering brands 112. For example, one partnering brand 112 may choose a lower price in exchange for reduced marketing content creation or media management.

In some embodiments, the partnering brands 112 may set daily spend values for participation in a dynamic brand partnership campaign 108 that is structured to run on an ongoing basis. For example, in one embodiment, the partnering brands 112 choose to specify ongoing daily spending budgets. Accordingly, the partnering brands 112 are placed into the brand partnership campaign 108, and each receives advertising/media exposure in proportion to its spending budget. If any partnering brand 112 decides to lower its daily spending budget, then the dynamic brand partnership campaign 108 will lower the brand's in accordance to the lower spending budget. Further, if the partnering brand 112 decides to stop its daily spending, then the partnering brand 112 exits the co-branded campaign 108 and their portion of the campaign concludes. The dynamic brand partnership campaign 108 will then omit the partnering brand's 112 creative from the collaborative campaign 108. It is contemplated that in such embodiments, the brand partnership campaign 108 may generate advertising content automatically and may allow for dynamic budget management for the participating brands 112.

Once the partnering brands 112 submit their payments or payment information, the administrator 104 can direct the partnership platform fee module 124 to charge a fee, such as 10%, to operate the campaign. The remaining funds can be dedicated to operating the partnership campaign by way of the campaign content development module 116 and the media management module 120. For example, in one embodiment, 80% of the funds is directed to the media management module 120 while 10% of the funds is directed to the campaign content development module 116. In the above-mentioned embodiment, wherein the three partnering brands 112 each paid $10K, the administrator 104 can direct $24K to the media management module 120 and $3K to the campaign content development module 116. Other fee structures will be apparent to those skilled in the art.

In the embodiment shown in FIG. 1, the brand partnership campaign 108 includes campaign components 128 that may be directed or performed by the campaign content development module 116 and the media management module 120. In some embodiments, the campaign content development module 116 may manage the operation of an advertising content component 132, a social assets component 136, and a hosting component 140. The advertising content component 132 may include production and testing of advertising content pertaining to the brand partnership campaign 108. For example, in an embodiment, the advertising content component 132 may include identifying and contracting a content creator, a creative director, a production studio, and/or specialized software to develop advertising content for the campaign. Further, the advertising content component 132 may manage and optimize advertising content across a variety of common online advertising placements, including, but not limited to, search ads, social media ads, newsfeed ads, content recommendation ads, audio ads, mobile ads, interstitial ads, video ads, in-stream ads, display ads, influencer ads, email ads, newsletter ads, native ads, promoted content ads, rich media ads, retargeting ads, carousel ads, affiliate marketing ads, newsletter ads, popup ads, pop under ads, and/or interactive ads.

In some embodiments, the social assets component 136 may include developing and providing each of the partnering brands 112 with a dashboard and reports on the performance of the brand partnership campaign. The hosting component 140 may, in some embodiments, include developing and hosting a shared landing page for the partnering brands 112. The shared landing page may comprise a micro-store that includes a combination of the products pertaining to the brand partnership campaign 108. For example, in a brand partnership campaign 108 that is related to eco-friendly kitchen products, the micro-store may include a combination of eco-friendly kitchen products from all of the partnering brands 112. In general, the shared landing page may be a “neutral” page that features products from all the participating partnering brands 112. Further, the hosting component 140 may develop a brand-specific page that includes a dashboard. It is contemplated that the dashboard may be configured to report to each of the partnering brands 112 on the performance of their portion of the brand partnership campaign.

As shown in FIG. 1, the media management module 120 may manage the operation of a budgeting component 144 and a campaign optimization component 148. In some embodiments, the budgeting component 144 manages and directs funding for advertising development and placement. For example, the budgeting component 144 may optimize funding across popular search engines, online advertising placements, sponsored newsletters, and the like. The campaign optimization component 148 may, in some embodiments, provide reporting and analytics to the partnering brands 112. The campaign optimization component 148 may collect and compile analytics to report to each of the partnering brands 112 on the performance of their portion of the brand partnership campaign 108.

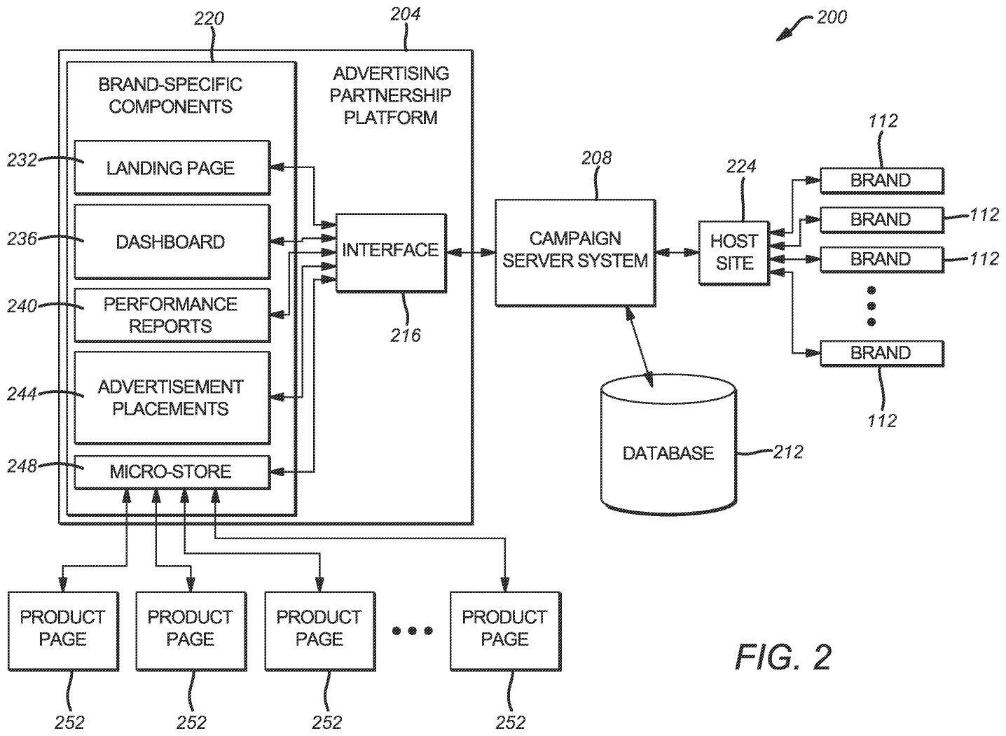

FIG. 2 is a schematic illustrating an exemplary embodiment of a brand-specific advertising and marketing platform 200 in accordance with the present disclosure. The platform 200 comprises an advertising partnership platform 204 that is provided and managed by a campaign server system 208. The advertising partnership platform 204 may be stored on a non-transient machine-readable medium (i.e., a memory) of the campaign server system 208 which comprises at least one processor and has connectivity to a database 212. Generally, the database 212 stores information pertaining to the brand partnership campaign 108 as well as the partnering brands 112. Further, the database 112 may store data and analytics pertaining to the performance of the brand partnership campaign 108. It is contemplated that the data stored on the database 112 may be used to develop reports to each of the partnering brands 112 on the performance of their portion of the brand partnership campaign 108.

In some embodiments, the advertising partnership platform 204 comprises an interface 216 that provides access to a brand-specific components suite 220. A host site 224 provides a multiplicity of partnering brands 112 access to the advertising partnership platform 204 by way of a communications network, such as the Internet. The partnering brands 112 comprise any of manufacturers, venders, retailers, service providers, media owners, non-profit organizations, NGOs, political organizations, entities promoting travel destinations, and the like, desiring to access and interact with status and performance data relating to the brand partnership campaign 108. In some embodiments, the host site 224 comprises a web-based application by which the partnering brands 112 interact with the suite of brand-specific components 220. In some embodiments, the host site 224 may comprise a customized web-based application that enables partnering brands 112 to directly interact with the suite of brand-specific components 220. In some embodiments, the host site 224 and the advertising partnership platform 204 may comprise a software application configured to operate on a mobile device, such as a cellphone, and communicate with the database 212 by way of the campaign server system 208.

Preferably, each of the partnering brands 112 may utilize applications stored on the memory of the campaign server system 208 to interact with the suite of brand-specific components 220 so as to access data and analytics pertaining to the performance of the brand partnership campaign 108. In one embodiment, the suite of brand-specific components 220 is stored on the memory of the campaign server system 208, and the interface 216 is a software application that comprises a portion of the advertising partnership platform 204 that provides access to the suite of brand-specific components 220. In some embodiments, the suite of brand-specific components 220 may be services operated by one or more third-party service providers. In such embodiments, the interface 216 may comprise a connection over a communications network, such as an Internet connection, whereby the campaign server system 208 may send requests to, and receive services from, the one or more third-party service providers.

The brand-specific components 220 generally comprise component modules whereby each partnering brand 112 may access and interact with data and analytics pertaining to the performance of the brand partnership campaign 108. In the illustrated embodiment of FIG. 2, the brand-specific components 220 includes a landing page 232, a dashboard 236, performance reports 240, advertising placements 244, and a micro-store 248. In some embodiments, however, the suite of brand-specific components 220 may comprise other modules in addition to the components illustrated in FIG. 2, without limitation and without deviating beyond the spirit and scope of the present disclosure.

The landing page 232 may, in some embodiments, comprise a shared landing page that features products from all the participating partnering brands 112. In other embodiments, however, the landing page 232 may be specific to each partnering brand 112, and thus enable the partnering brand 112 to view and interact with its portion of the brand partnership campaign 108. In some embodiments, the landing page 232 may provide access to a micro-store that includes a combination of the products pertaining to the brand partnership campaign 108. As mentioned above, for example, in a brand partnership campaign 108 that is related to eco-friendly kitchen products, the micro-store may include a combination of eco-friendly kitchen products from all of the partnering brands 112. As such, the landing page 232 may provide the partnering brands 112 with access to a “neutral” page that features products from all the participating partnering brands 112.

It should be borne in mind that the landing page 232 is not limited to being a micro-store. For example, in an embodiment of a campaign 108 that hires a YouTube influencer to discuss multiple partnering brands 112 and promotes the video with paid advertisements, the description of the video may comprise a landing page 232 that includes links to each of the multiple partnering brands 112. In another example, the landing page 232 may comprise an influencer website page that includes links to all of the multiple partnering brands 112. In some embodiments, an influencer may have a store selling products offered by the multiple partnering brands 112. Thus, through the advertising partnership platform, the partnering brands 112 can pay the influencer to promote their products in a shared video ad and then send traffic to the influencer store. Further, in some embodiments, the landing page 232 may be a social media post having links to all of the multiple partnering brands 112. In some embodiments, the landing page 232 may comprise a promotional podcast episode that has links to all of the multiple partnering brands 112. Further, the landing page 232 may comprise a press-release piece or a sponsored or commissioned editorial article to which advertisements are linked. As an example, an embodiment of a PR piece can mention the “top 5 eco-kitchen products” and the campaign 108 can run advertisements that link to the PR page or to the editorial article.

The dashboard 236 may be configured to report to each of the partnering brands 112 on the performance of their portion of the brand partnership campaign 108. The dashboard 236 may comprise a graphical user interface whereby each partnering brand 112 may view and access data and analytics pertaining to the performance of the brand partnership campaign 108. The dashboard 236 may comprise one or more graphical elements, such as on-screen buttons, that are configured to commence the retrieval of campaign-related data from campaign server system 208 and/or the database 212. In some embodiments, the dashboard 236 may be configured to display the campaign-related data in the form of performance reports 240. Such performance reports 240 may utilize data stored on the database 112 to inform the partnering brands 112 about the performance of their portion of the brand partnership campaign 108.

Moreover, the dashboard 236 may be configured to display data and analytics pertaining to advertising placements 244. Data related to advertising placements 244 may be configured to display advertising performance data as a function of the placement of each advertisement. As will be appreciated, customer response to advertising content across a variety of advertising placements generally will vary. In some embodiments, the advertising placements 244 may be display campaign-performance data arising due to each advertising placement. As such, the advertising placements 244 generally enable partnering brands 112 to manage and optimize advertising content across a variety of common online advertising placements, including, but not limited to, search ads, social media ads, newsfeed ads, content recommendation ads, audio ads, mobile ads, interstitial ads, video ads, in-stream ads, display ads, influencer ads, email ads, newsletter ads, native ads, promoted content ads, rich media ads, retargeting ads, carousel ads, affiliate marketing ads, newsletter ads, popup ads, pop under ads, and/or interactive ads.

The micro-store 248 comprises a shared landing page that includes a combination of the products from all of the partnering brands 112 pertaining to the brand partnership campaign 108. In some embodiments, the micro-store 248 may redirect customers to specific product pages 252 based on their selections in the micro-store 248. It is contemplated that each of the specific product pages 252 is related to one product that is listed among the many products included in the micro-store 248. Further, it is contemplated that the specific product pages 252 are particular to specific partnering brands 112 based on the products being advertised on each page.

As mentioned above with respect to the landing page 232, the micro-store 248 is not limited to being a shared page that includes a combination of products from all the partnering brands 112. In some embodiments, for example, the micro-store 248 may include multiple links to all of the web sites of all the partnering brands 112. In an exemplary embodiment, the micro-store 248 may comprise an influencer website page that includes links to all of the multiple partnering brands 112. In some embodiments, an influencer may have a store selling products offered by the multiple partnering brands 112. Thus, the partnering brands 112 can pay the influencer to promote their products in a shared video ad and then send traffic to the influencer store. Further, in some embodiments, the micro-store 248 may be a social media post having links to all of the multiple partnering brands 112. In some embodiments, the micro-store 248 may comprise a promotional podcast episode that has links to all of the multiple partnering brands 112. Further, the micro-store 248 may comprise a press-release piece to which advertisements are linked. As an example, an embodiment of a PR piece can mention the “top 5 eco-kitchen products” and the campaign 108 can run advertisements that link to the PR page. The PR piece may include links to all of the multiple partnering brands 112.

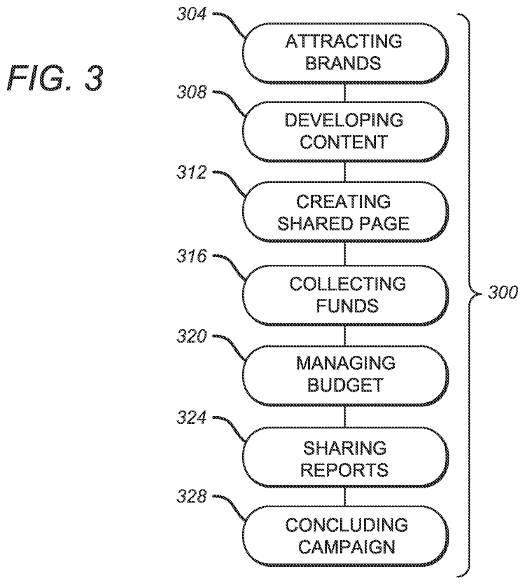

Turning, now, to FIG. 3, a process 300 for managing a collaborative advertising and marketing campaign in accordance with the present disclosure is shown. The process 300 may begin with step 304 wherein a campaign may be posted to attract brands. In some embodiments, the campaign platform administrator 104 may post a campaign brief directed to one or more product types that may be advertised by way of an advertising partnership. For example, the administrator 104 may post a campaign brief describing a brand partnership campaign 108 for eco-friendly kitchen products so as to attract partnering brands 112 that offer products or services related to eco-friendly kitchen products. In one embodiment, for example, the partnering brands 112 may comprise an organic kitchen towel brand, a soap bar brand, and a silicon bags brand. The partnering brands 112 may then enter into a contractual agreement with the administrator 104 and submit their payments or billing information, as described herein.

In some embodiments, step 304 may comprise contacting potential partnering brands 112 directly by way of an algorithm or manual labor, in lieu of posting a campaign brief, as described above. For example, a sales team or artificial intelligence algorithms may be used to identify candidate brands and then form suitable groups of potential partnering brands 112. In some embodiments, machine learning may be used to group potential partnering brands 112 together. In some embodiments, a social media/advertising platform may identify two or more potential partnering brands 112 and then contact the brands, such as by way of displaying a popup, asking about participating in the brand partnership campaign 108. When the potential partnership brands 112 agree to participate in the brand partnership campaign 108, an artificial intelligence may create co-branded advertisements that include links to each of the partnership brands 112.

Moreover, in some embodiments, step 304 may comprise, for example, an influencer setting up a shop with products derived from multiple brands. It is contemplated that the influencer may use a software tool to merge products from various branded e-shops into the influencer's e-shop and then ask to split the cost of the advertising between the brands hosted on the influencer's e-shop.

It is contemplated that the brand partnership campaign 108 is not to be limited to physical products, as described hereinabove. Rather, in some embodiments, the brand partnership campaign 108 may be directed to advertising digital products and services, including, by way of non-limiting example, online courses, webinars, e-books, software, investment opportunities, subscriptions, membership sites, newsletters, apps, music tracks, movies, shows, streaming channels, artists, influencers, social media accounts, stock videos and photos, freelancers and consultants, agencies, video gaming experiences, virtual reality experiences, augmented reality experiences, and the like. In some embodiments, the brand partnership campaign 108 may be directed to a collaboration that involves a raffle/giveaway, wherein the partnering brands 112 agree to split advertising budgets to promote a collaborative giveaway. Further, in some embodiments, the brand partnership campaign 108 may be directed to collecting email leads that are then marketed to by all the partnering brands 112. For example, the partnering brands 112 may comprise a plumbing service, an electric service and a roofing company that use the brand partnership campaign 108 to obtain leads comprising homeowners and then market services to the homeowners. Other collaboration models will be apparent to those skilled in the art.

In some embodiments, the brand partnership campaign 108 may be directed to lead generation advertisements. In such embodiments, users are not directed from an advertisement platform to a landing page but rather may submit their information directly to a form within the advertisement platform. The brand partnership campaign 108 can collect the contact information and then communicate with the users by way of text messages and/or email to promote the partnering brands 112. As an example, in one embodiment, 10 coffee shops in New York City comprise partnering brands 112 participating in a brand partnership campaign 108. The campaign 108 manages an Instagram page that publishes an advertisement asking users to “sign up to get discounts for the top 10 coffee shops in NYC.” The users may sign up within an advertisement platform. The brand partnership campaign 108 then sends text messages, direct message, and/or emails with content about the 10 partnering brands 112. As will be recognized, the 10 partnering brands 112 share the cost of the brand partnership campaign 108.

In some embodiments, the brand partnership campaign 108 may be directed to brand recognition rather than to advertising specific products or services. For example, in an embodiment of a brand partnership campaign 108, a YouTube influencer may be hired to discuss one or more partnering brands 112 for the purpose of raising awareness of the brands and their products or services. The campaign 108 may promote the video with paid advertisements, and the description of the video may include links directly to websites of the partnering brands 112. It is contemplated that such embodiments of the brand partnership campaign 108 may omit the landing page 232 and the micro-store 248.

Once participating brands have joined the brand partnership campaign 108, the process 300 advances to a content development step 308. In step 308, an advertising content component 132 (see FIG. 1) may develop production and testing of advertising content pertaining to the brand partnership campaign 108. In an embodiment, for example, the advertising content component 132 may include identifying and contracting a content creator, a creative director, a production studio, or software to develop advertising content for the campaign. Further, the advertising content component 132 may manage and optimize advertising content across a variety of common online advertising placements, including, but not limited to, search ads, social media ads, newsfeed ads, content recommendation ads, audio ads, mobile ads, interstitial ads, video ads, in-stream ads, display ads, influencer ads, email ads, newsletter ads, native ads, promoted content ads, rich media ads, retargeting ads, carousel ads, affiliate marketing ads, newsletter ads, popup ads, pop under ads, and/or interactive ads.

As mentioned above, in some embodiments, a social media/advertising platform may identify two or more potential partnering brands 112 and then contact the brands, such as by way of displaying a popup, asking about participating in the brand partnership campaign 108. When the potential partnership brands 112 agree to participate in the brand partnership campaign 108, an artificial intelligence may create co-branded advertisements that include links to each of the participating brands 112. Further, in some embodiments, a brand partnership campaign 108 may be configured to automatically match companies within its database and then automatically create a video creative that is a collage of multiple matched brands. The brand partnership campaign 108 may contact the matched brands to let them opt-in and share the advertising cost.

In step 312, a hosting component 140 comprising the brand partnership campaign 108 may create a shared landing page for the campaign. The shared landing page may comprise a micro-store that includes a combination of the products pertaining to the brand partnership campaign 108. In an exemplary embodiment, a brand partnership campaign 108 that is related to the above-mentioned eco-friendly kitchen products, the micro-store may include a combination of eco-friendly kitchen products from all of the partnering brands 112, such as organic kitchen towels, eco-friendly soap bars, environmentally friendly silicon bags, and the like. In general, the shared landing page may be a “neutral” page that features products from all the participating partnering brands 112. Further, the hosting component 140 may develop a brand-specific page that includes a dashboard. It is contemplated that the dashboard may be configured to report to each of the partnering brands 112 on the performance of their portion of the brand partnership campaign.

In step 316, the process 300 may advance to collecting funds. As described above, the partnering brands 112 share the cost of operating the brand partnership campaign 108 and consequently their brands will reach more potential customers due to combined media spending. In one embodiment, for example, in step 316 three partnering brands 112 may be directed to make equal payments, such as $50K each, to the administrator 104 to operate the brand partnership campaign 108. Thus, each of the partnering brands 112 will receive $150K worth of advertising exposure for a cost of $50K. It is contemplated that the advertising exposure will generally grow in direct proportion to the number of partnering brands 112 that join the campaign.

It should be noted that the payments need not be equal, but rather, in some embodiments, the partnering brands 112 may pay different amounts of money. For example, in some embodiments, one or more of the partnering brands 112 may pay more for a higher position on a landing page or a more prominent position in a photo advertisement. Further, in some embodiments, one or more of the partnering brands 112 may opt to pay relatively less than other partnering brands 112. For example, one partnering brand 112 may choose a lower price in exchange for reduced marketing content creation or media management.

Once the partnering brands 112 submit their payments, in step 320 the administrator 104 can direct the partnership platform fee module 124 to direct a small fee, such as 10%, to operate the campaign and direct the remaining funds toward operating the partnership campaign. For example, in one embodiment described in connection with FIG. 1, 80% of the funds is directed to the media management module 120 while 10% of the funds is directed to the campaign content development module 116. Thus, in the above-mentioned embodiment, wherein the three partnering brands 112 each paid $50K, the administrator 104 can direct $120K to the media management module 120 and $15K to the campaign content development module 116.

In some embodiments, in step 320, the media management module 120 (see FIG. 1) may manage the operation of a budgeting component 144 and a campaign optimization component 148. The budgeting component 144 generally manages and directs funding for advertising development and placement. For example, the budgeting component 144 may optimize funding across popular search engines, online advertising placements, and sponsored newsletters, and the like. The campaign optimization component 148 may, in step 324, provide reporting and analytics to the partnering brands 112. The campaign optimization component 148 may collect and compile analytics to report to each of the partnering brands 112 on the performance of their portion of the brand partnership campaign 108. It is contemplated that steps 320 and 324 continue until the process 300 concludes in step 328. As will be appreciated, the process 300 concludes with the brand partnership campaign 108 finishes.

It should be borne in mind that any one or more of the steps 304-328 may be performed by way of an artificial intelligence or machine learning to provide partnering brands 112 with a more autonomous experience. For example, it is contemplated that the artificial intelligence or machine learning may be used to perform tasks such as making advertising content, making landing pages, sending customers directly to landing pages, social media profiles, or web sites of the partnering brands 112, and the like. In some embodiments, the artificial intelligence or machine learning can be configured to develop creative content for the brand partnership campaign 108, in lieu of personnel such as a creative director and/or content creators. Further, in some embodiments, the artificial intelligence or machine learning can dynamically generate advertisements based on assets of the partnering brands 112 as well as create a landing page for the partnering brands 112.

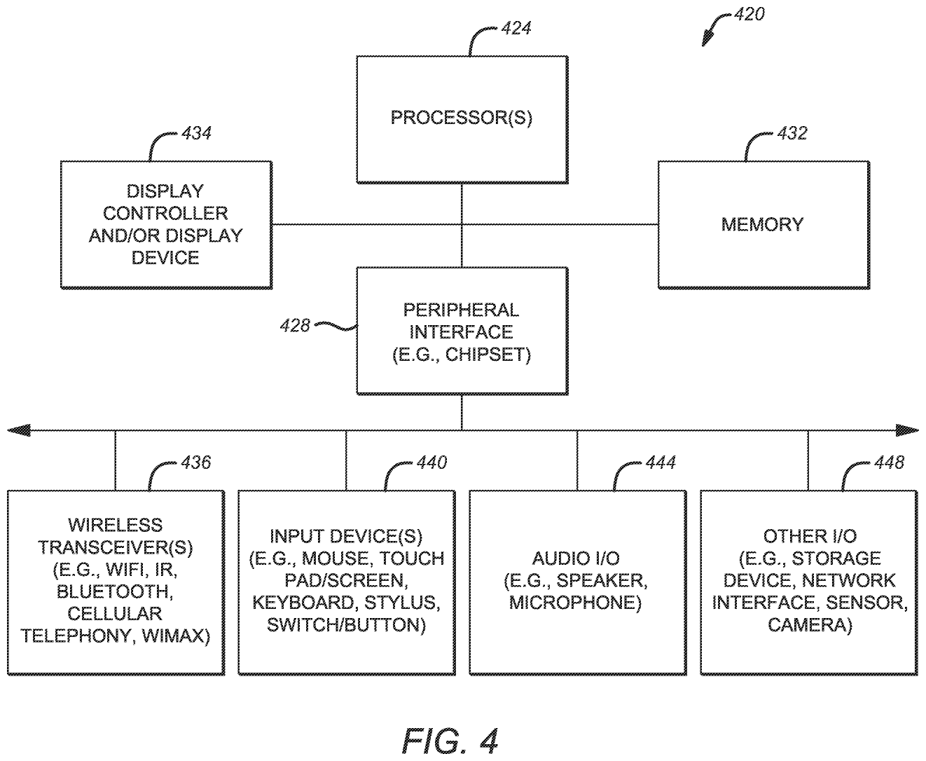

FIG. 4 is a block diagram illustrating an exemplary data processing system 420 that may be used in conjunction with a brand partnership campaign 108 to perform any of the processes or methods described herein. System 420 may represent a desktop, a tablet, a server, a mobile phone, a personal digital assistant (PDA), a personal communicator, a network router or hub, a wireless access point (AP) or repeater, a set-top box, or a combination thereof.

In an embodiment, illustrated in FIG. 4, system 420 includes a processor 424 and a peripheral interface 428, also referred to herein as a chipset, to couple various components to the processor 424, including a memory 432 and devices 436-448 via a bus or an interconnect. Processor 424 may represent a single processor or multiple processors with a single processor core or multiple processor cores included therein. Processor 424 may represent one or more general-purpose processors such as a microprocessor, a central processing unit (CPU), or the like. More particularly, processor 424 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 424 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 424 is configured to execute instructions for performing the operations and steps discussed herein.

Peripheral interface 428 may include a memory control hub (MCH) and an input output control hub (ICH). Peripheral interface 428 may include a memory controller (not shown) that communicates with a memory 432. The peripheral interface 428 may also include a graphics interface that communicates with graphics subsystem 434, which may include a display controller and/or a display device. The peripheral interface 428 may communicate with the graphics device 434 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 424. In such a configuration, the peripheral interface 428 operates as an interface chip performing some functions of the MCH and ICH. Furthermore, a graphics accelerator may be integrated within the MCH or the processor 424.

Memory 432 may include one or more volatile storage (or memory) devices, such as random access memory (RAM), dynamic RAM (DRAM), synchronous DRAM (SDRAM), static RAM (SRAM), or other types of storage devices. Memory 432 may store information including sequences of instructions that are executed by the processor 424, or any other device. For example, executable code and/or data of a variety of operating systems, device drivers, firmware (e.g., input output basic system or BIOS), and/or applications can be loaded in memory 432 and executed by the processor 424. An operating system can be any kind of operating system, such as, for example, Windows® operating system from Microsoft®, Mac OS®/iOS® from Apple, Android® from Google®, Linux®, Unix®, or other real-time or embedded operating systems such as VxWorks.

Peripheral interface 428 may provide an interface to IO devices, such as the devices 436-448, including wireless transceiver(s) 436, input device(s) 440, audio IO device(s) 444, and other IO devices 448. Wireless transceiver 436 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 440 may include a mouse, a touch pad, a touch sensitive screen (which may be integrated with display device 434), a pointer device such as a stylus, and/or a keyboard (e.g., physical keyboard or a virtual keyboard displayed as part of a touch sensitive screen). For example, the input device 440 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 444 may include a speaker and/or a microphone to facilitate voice-enabled functions, such as voice recognition, voice replication, digital recording, and/or telephony functions. Other optional devices 448 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 448 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 4 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the collaborative advertising and marketing platform and methods have been described in terms of particular variations and illustrative figures, those of ordinary skill in the art will recognize that the collaborative advertising and marketing platform is not limited to the variations or figures described. In addition, where methods and steps described above indicate certain events occurring in certain order, those of ordinary skill in the art will recognize that the ordering of certain steps may be modified and that such modifications are in accordance with the variations of the collaborative advertising and marketing platform. Additionally, certain of the steps may be performed concurrently in a parallel process, when possible, as well as performed sequentially as described above. Further, certain of the steps described above may be omitted or skipped, as desired, without deviating from the present disclosure. To the extent there are variations of the collaborative advertising and marketing platform, which are within the spirit of the disclosure or equivalent to the collaborative advertising and marketing platform found in the claims, it is the intent that this patent will cover those variations as well. Therefore, the present disclosure is to be understood as not limited by the specific embodiments described herein, but only by scope of the appended claims.

What is claimed is:

1. A process for managing a brand partnership campaign, comprising:
attracting partnering brands;
developing advertising content;
collecting funds from the partnering brands;
producing reports with partnering brands; and
concluding the brand partnership campaign.

2. The process of claim 1, wherein attracting partnering brands comprises contacting potential partnering brands directly by way of an algorithm or manual labor, in lieu of posting a campaign brief.

3. The process of claim 2, wherein contacting includes using a sales team to identify candidate partnering brands and then forming suitable groups of potential partnering brands.

4. The process of claim 2, wherein contacting includes an artificial intelligence or automation to identify candidate partnering brands and forming suitable groups of potential partnering brands.

5. The process of claim 4, wherein forming includes creating co-branded advertisements that include links to a website for each participating partnership brand.

6. The process of claim 1, further comprising creating a shared landing page.

7. The process of claim 6, wherein creating comprises creating a micro-store that includes a combination of products from all the partnering brands.

8. The process of claim 6, wherein creating comprises a specialized software or artificial intelligence generating a landing page comprising written and/or graphic content featuring the partnering brands.

9. The process of claim 6, wherein creating comprises including one or more links to all of the websites, product pages, or apps, of all of the partnering brands.

10. The process of claim 9, wherein creating comprises creating a social media post having links to all of the partnering brands.

11. The process of claim 9, wherein creating comprises creating a promotional podcast episode or a promotional video that has one or more links to any one or more of the partnering brands.

12. The process of claim 9, wherein creating comprises creating a blog post, press-release or editorial piece to which advertisements are linked.

13. The process of claim 9, wherein creating comprises an influencer, writer, or editor creating a website page that includes links to all of the partnering brands.

14. The process of claim 13, wherein creating the micro-store includes using a software tool to merge various products from the partnering brands into the website page.

15. The process of claim 1, wherein developing advertising content comprises using an artificial intelligence to create co-branded advertisements that may include links to each of the partnership brands.

16. The process of claim 1, wherein developing advertising content comprises using an artificial intelligence to create advertising content that is a collage of the partnering brands.

17. The process of claim 1, wherein developing advertising content comprises using an artificial intelligence to match brands stored within a database comprising the brand partnership campaign and contact the matched brands to let them opt-in and share the advertising cost.

18. The process of claim 1, wherein developing advertising content comprises providing or utilizing an advertising platform that directs users to submit information directly to a form within the advertisement platform and then sends text messages, direct messages, and/or emails with content about the partnering brands.

19. The process of claim 1, wherein developing advertising content comprises promoting a collaborative raffle/giveaway.

20. The process of claim 1, wherein developing advertising content comprises collecting customer leads that are to be marketed to by the partnering brands.

21. The process of claim 1, wherein developing advertising content comprises advertising digital products, services, or content.

22. The process of claim 1, wherein developing advertising content comprises raising awareness of the partnering brands and their products or services.
